(19) United States
(12) Patent Application Publication
(10) Pub. No.: US 2011/0035670 A1
(43) Pub. Date: Feb. 10, 2011

(54) AUDIO PLAYBACK METHOD FOR ELECTRONIC DEVICE

(75) Inventors: TENG-YU TSAI, Tu-Cheng (TW); KAI-HO HSIUNG, Tu-Cheng (TW); TUN-TAO TSAI, Tu-Cheng (TW); PENG-ZHENG YANG, Tu-Cheng (TW); CHIH-YUAN CHUANG, Tu-Cheng (TW); CHUN-WEN WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/617,949

(22) Filed: Nov. 13, 2009

(30) Foreign Application Priority Data
Aug. 10, 2009 (CN) 200910305455.3

(51) Int. Cl. G06F 3/048

(52) U.S. Cl. 715/716

(57) ABSTRACT

A method for audio playback in an embedded electronic device includes an audio file list with a plurality of audio files displayed on, a playlist created in a storage module by selection of at least one audio file from the audio file list. An audio file is played in the playlist by a playback module. An operating state of the active audio file is fed back to the storage module. The operating state is acquired and displayed by a user interface.

### BACKGROUND

1. Technical Field

The disclosure generally relates to audio playback methods for embedded electronic devices.

2. Description of Related Art

Embedded electronic devices, such as digital cameras, set-top boxes, digital phone frames, and others, provide many functions, such as audio playback, reading documents, browsing websites, and others. The electronic device can be operated to play back audio through user interface (UI) and a music program. An operating state of the audio file is directly received and displayed by the UI. When the UI is shut down, the audio file is shut down at the same time. A better way to play audio files in an electronic device is needed.

### BRIEF DESCRIPTION OF THE DRAWINGS

FIG. 1 is a block view of an embedded electronic device providing audio playback.

FIG. 2 is a flowchart of a method for audio playback in an embedded electronic device according to the embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

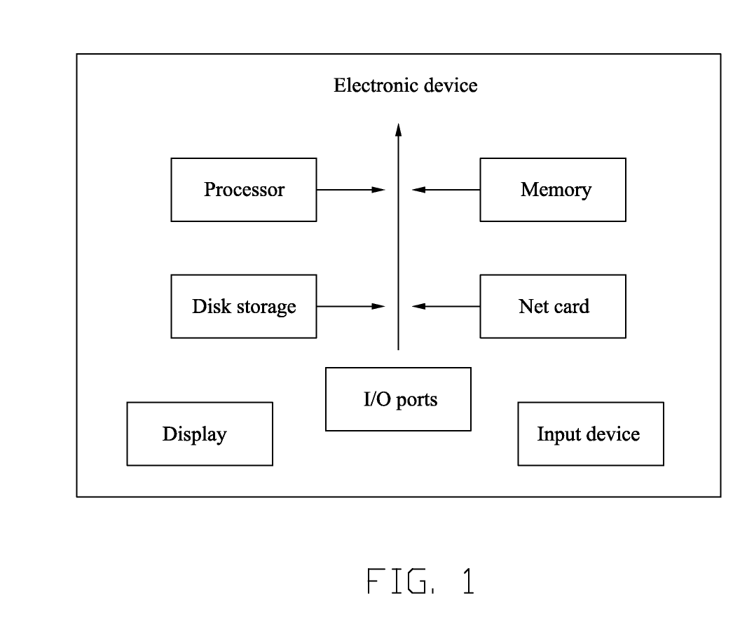

Referring to FIG. 1, an embedded electronic device includes a processor, a memory, a disk storage, a net card, input/output (I/O) ports, an input device and a display. The embedded electronic device has an embedded operation system, such as Linux operating system. The embedded electronic device has a playback module operating as a background program providing playback of multimedia files. A user interface (UI) is provided to manage the audio files in the electronic device. The playback module can operate independent of the UI.

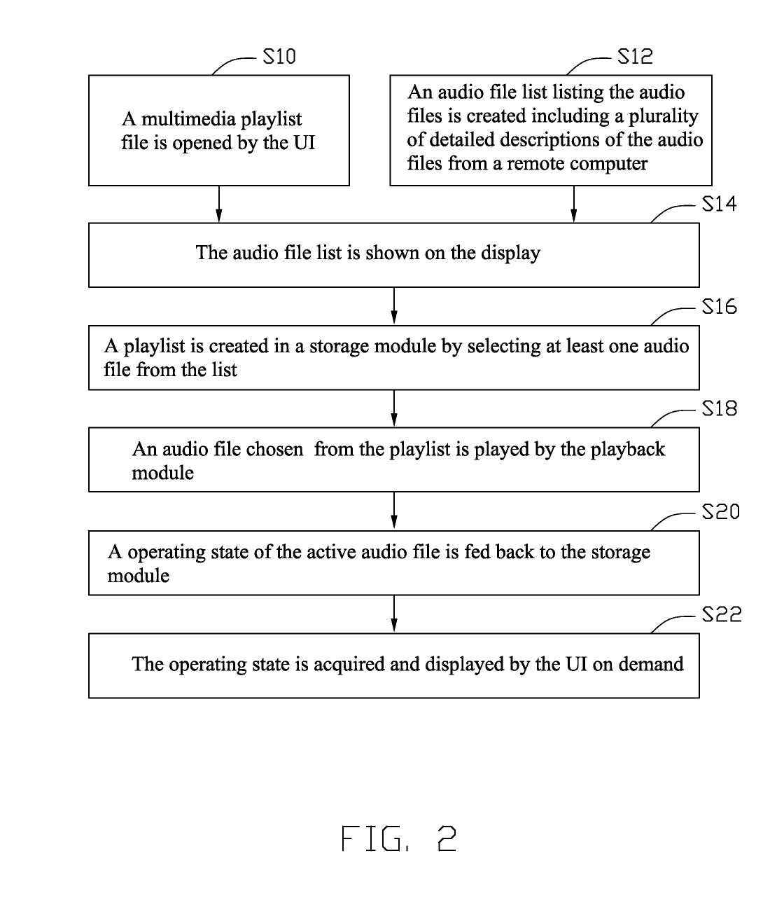

Referring to FIG. 2, a method for audio playback in the embedded electronic device according to an embodiment includes the following steps.

In step S10, a multimedia playlist file is opened by the UI. The multimedia playlist file contains locations of audio files. For example, the multimedia playlist file can be a moving picture experts group audio layer 3 uniform resource locator (M3U) format file. The UI checks location of each audio file and the UI creates an audio file list by preserving determined locations of the audio files.

In step S12, an audio file list listing the audio files is created including a plurality of detailed descriptions of the audio files from a remote computer.

In step S14, the audio file list received from step S10 or step S12 is shown on the display. All selected audio files are displayed on the audio file list in a detailed description, and the audio files are sorted by the detailed description. The detailed description includes at least one of name, format, play duration, performer, album art, and a location of the audio file when the audio file comes from the remote computer. A scroll bar is loaded when the detailed description exceeds a display area. Either one of step S10 and step S12 can be preformed before step S14 is implemented.

In step S16, a playlist is created in a storage module by selecting at least one audio file from the list. The storage module is a block of memory acting as the disk storage of the electronic device.

In step S18, an audio file chosen from the playlist is played by the playback module. The chosen audio file and playing control command from the UI are executed by the playback module.

In step S20, an operating state of the active audio file is fed back to the storage module. The operating state includes progress of the active audio file and album art of the active audio file.

In step S22, the operating state is acquired and displayed by the UI on demand, so other UIs provided by other programs can directly fetch the operating state of the active audio file and control the audio file.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for audio playback in an embedded electronic device comprising:
displaying an audio file list with a plurality of audio files;
creating a playlist in a storage module by selecting at least one audio file from the audio file list;
playing an audio file from the playlist by a playback module;
feeding back an operating state of the active audio file to the storage module; and
acquiring and displaying the operating state by a user interface.

2. The method of claim 1 wherein the audio files are displayed on the audio file list in a detailed description, and the audio files are sorted by the detailed description.

3. The method of claim 2, wherein the detailed description comprises at least one of name, format, play duration and performer.

4. The method of claim 2, wherein the detailed description comprises album art.

5. The method of claim 2, wherein a scroll bar is loaded when the detailed description exceeds a display area.

6. The method of claim 2 further comprising acquiring the detailed description of the audio files via a remote computer, the detailed description of the audio file comprises location addresses of the audio files.

7. The method of claim 1 further comprising:
opening a multimedia playlist file, wherein the multimedia playlist file contains locations of the audio files;
checking each location of the audio file; and
creating the audio file list by preserving correct locations of the audio files.

8. The method of claim 1, wherein the operating state comprises a playing progress of the active audio file and an album art of the active audio file.

9. The method of claim 1, wherein the storage module is a block of memory acting as a disk storage of the electronic device.

10. The method of claim 1 further comprising decoding the audio file and executing playing control command by the playback module.

11. The method of claim 1, wherein the playback module operates independent of the user interface.
